(19) United States
(12) Patent Application Publication
(10) Pub. No.: US 2004/0019702 A1
(43) Pub. Date: Jan. 29, 2004

(54) System for rewriting a VLAN-ID in an Ethernet frame containing VLAN-ID's

(76) Inventors: Tadanori Kojima, Tokyo (JP); Toshiya Asaba, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 10/417,204

(22) Filed: Apr. 17, 2003

(30) Foreign Application Priority Data
Apr. 18, 2002 (JP) 116261/2002

(51) Int. Cl. G06F 15/16

(52) U.S. Cl. 709/250

(57) ABSTRACT

A system for rewriting a VLAN-ID in an Ethernet frame containing VLAN-IDs is provided to solve a communications problem that could arise due to the difference between IDs in a plurality of interconnected networks employing different schemes for determining an ID. In a VLAN comprised of a plurality of interconnected Ethernet networks (N_{X}, N_{Y}), converters (CONV_{X}, CONV_{Y}) for converting a user ID in one of the Ethernet networks to another ID of the same user in another Ethernet network is provided in an interface portion where the plurality of Ethernet networks are connected. The converters make it possible to uniquely identify all the users by their IDs throughout the VLAN.

### BACKGROUND OF THE INVENTION

The present invention pertains generally to data communications technology and in particular to a system for rewriting an identifier in an Ethernet frame in a network-network interface (NNI) when a plurality of networks are to be connected. Please note that an indication of a registered trademark for the registered trademark “Ethernet” network is omitted throughout the specification as it is used repeatedly.

User IDs contained in the header portion of an Ethernet frame are determined network by network. Thus, communications beyond the boundary between Ethernet networks in a virtual LAN (VLAN) spanning a plurality of Ethernet networks cannot be effected because different VLAN-IDs are used for the same user in different Ethernet networks.

### SUMMARY OF THE INVENTION

With a view to solving the aforementioned problem, a communications system of the present invention installs a converter for converting a user ID in an Ethernet network to a user ID in another Ethernet network in an interface portion where a plurality of Ethernet networks are interconnected in a VLAN spanning a plurality of interconnected Ethernet networks. The converter enables a user ID to be made unique throughout a VLAN spanning a plurality of Ethernet networks.

### BRIEF DESCRIPTION OF THE DRAWINGS

FIG. 1 is an illustration of a connection between two networks.

FIG. 2 illustrates a problem that could arise due to the disparity between IDs assigned to two networks at the time of communication between the two networks.

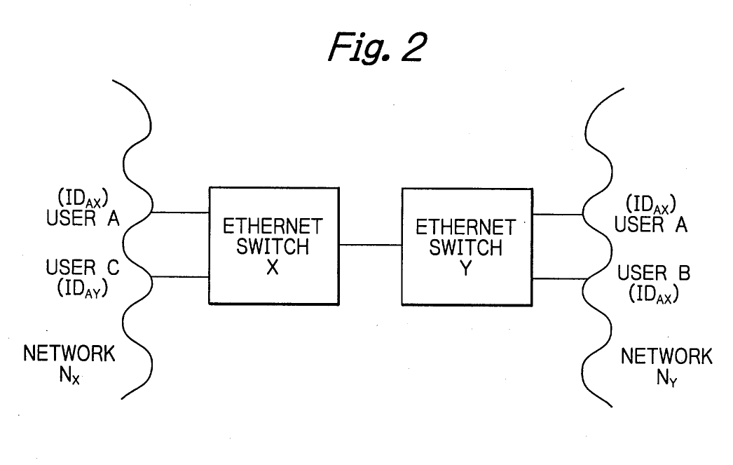

FIG. 3 is a schematic diagram of a converter provided between two networks in accordance with the present invention.

### DETAILED DESCRIPTION OF THE INVENTION

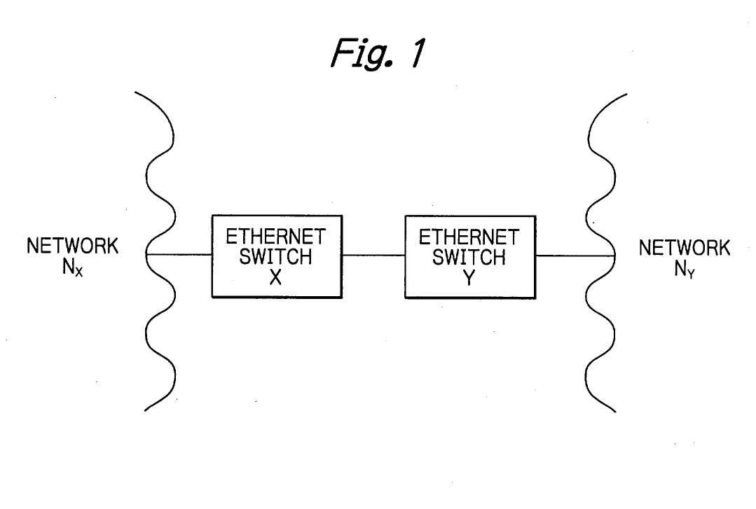

FIG. 1 shows a configuration wherein an Ethernet switch X and an Ethernet switch Y are connected to each other. For example, the Ethernet switches X and Y are included in networks N_{X} and N_{Y} installed by two separate business entities and the two networks N_{X} and N_{Y} are connected by connecting the switch X to the switch Y. It is assumed in the present embodiment that the two networks N_{X} and N_{Y} are LANs each equipped with a VLAN function and the networks N_{X} and N_{Y} are connected to each other to form an expanded VLAN. For example, a 1000 Base LX may be selected for a connection interface by taking into consideration a band and a distance between a point of interconnection (POI) and an access point (AP) or it may be made 10G when data capacity is expected to increase in the future. Further, a line may be made duplex and system switching is conducted by means of a spanning tree between Ethernet switches at both ends of an interface. An Ethernet frame executes a VLAN trunking protocol of IEEE Standard 802.1Q. However, such details of an interface and a line as described above do not have a direct bearing on the content of the present invention and may be determined according to the condition of the networks N_{X} and N_{Y}.

When connecting the Ethernet switch X directly to the Ethernet switch Y as indicated in FIG. 1, a disparity in VLAN-IDs between the networks to which the switches X and Y belong must be resolved. More specifically, when a VLAN-ID assigned to an end user in the network N_{X} on the Ethernet switch X side is different from a VLAN-ID assigned to the same end user in the network N_{Y} on the Ethernet switch Y side, communications between the networks cannot be established.

VLAN-IDs are typically assigned network by network. Therefore, when a user A owns an ID_{AX} in the network N_{X} and an ID_{AY} in the network N_{Y}, the ID_{AX} and ID_{AY} are usually not the same. When the user A's IDs in the networks N_{X} and N_{Y} do not match, a traffic addressed to the user A in the network N_{Y} sent from the network N_{X} might be sent to a user B instead of the user A in the network N_{Y}. Similarly, a traffic addressed to the user A in the network N_{X} sent from the network N_{Y} might be sent to a user C instead of the user A in the network N_{X}. In other words, when connecting a plurality of VLANs adopting different ID determination schemes, a user P shared by at least two networks in the plurality of VLANs is not uniquely identified by the two networks because the determination scheme of the user P's ID is not unique in each of the networks.

With a view to obviating the aforementioned problems, the inventors of the present invention propose a system wherein a plurality of networks are interconnected and when communicating between at least two networks, the ID of a user assigned in the sending network is converted into the corresponding ID of the same user assigned in the receiving network by referring to a table listing corresponding relationships between IDs in the communicating networks such that the ID in the sending network uniquely corresponds to the ID in the receiving network.

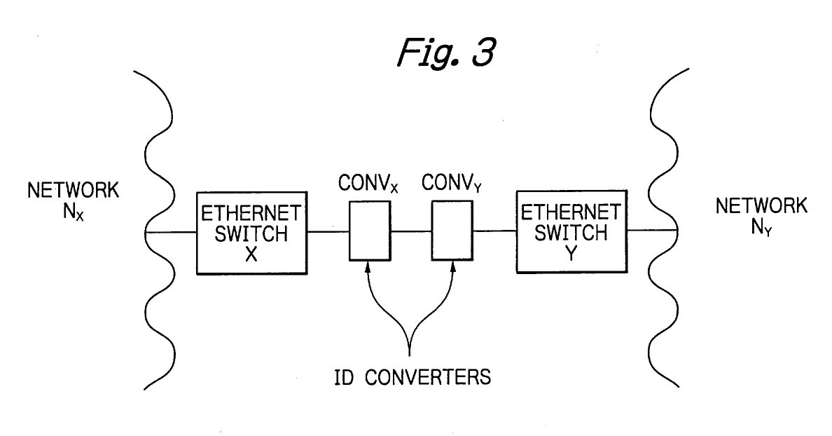

It is assumed now that a plurality of Ethernet networks are interconnected and an Ethernet frame is sent from one Ethernet network to another Ethernet network. When moving a VLAN-ID contained in an Ethernet frame from a first Ethernet network to a second Ethernet network, a converter for converting a VLAN-ID in the first Ethernet network to another VLAN-ID in the second Ethernet network may be provided. FIG. 3 shows such converters (CONV_{X}, CONV_{Y}). In the example indicated in FIG. 3, a converter is provided on the switch side of each network. For example, when an Ethernet frame moves from the network N_{X} to the network N_{Y}, an ID in the network N_{X} is first converted by the converter (CONV_{X}) on the network N_{X} side to another ID common to the both networks N_{X} and N_{Y}, which is further converted to still another ID in the network N_{Y} by the converter (CONV_{Y}) on the network N_{Y} side and vice versa. Instead of employing two converters, a single converter designed to perform both the functions mentioned above may be employed.

For a user P shared by the network N_{X} and the network N_{Y}, the converter incorporates a table showing a relationship between the user P's ID in the network N_{X} and the same user's ID in the network N_{Y}. In other words, a converter contains a storage for storing such a correspondence table, which is referred to at the time of converting an ID between two networks.

If such a converter as described above is provided at an interface portion between two networks connected to each other, each user's IDs in the networks can be uniquely used for communications between the networks even though each user has different IDs in the different networks, whereby communications beyond the boundary between networks becomes possible.

While preferred embodiments of the present invention have been illustrated and described, numerous variations, modifications and alternate embodiments will occur to those skilled in the art. Such variations, modifications and alternate embodiments can be effected without departing from the spirit and scope of the invention as defined in the appended claims.

What is claimed is:

1. A communications system in which a plurality of networks are interconnected and identifiers of users belonging to said plurality of networks are determined network by network, said communications system comprising:
identifier correspondence state storage means for storing a correspondence state between identifiers of each user belonging to at least two networks of said plurality of networks; and
interface means connected to said identifier correspondence state storage means for connecting a first network to a second network of said plurality of networks and converting identifiers of a user shared by said first and second networks from his/her identifier in said first network to that in said second network and vice versa by referring to said identifier correspondence state storage means.

2. The communications system as defined in claim 1, wherein said plurality of networks are virtual LANs and said identifiers of a user are VLAN-IDs.

3. A method for interconnecting a plurality of networks in which identifiers of users belonging to said plurality of networks are determined network by network, said method comprising the steps of:
storing a correspondence state between identifiers of each user belonging to at least two networks of said plurality of networks; and
converting, when connecting a first network to a second network of said plurality of networks, identifiers of a user shared by said first network and second network from his/her identifier in said first network to that in said second network and vice versa with reference to said stored identifier correspondence state.

4. The method as defined in claim 3, wherein said plurality of networks are virtual LANs and said identifiers of a user are VLAN-IDs.
